(19) United States
(12) Patent Application Publication
(10) Pub. No.: US 2021/0387743 A1
(43) Pub. Date: Dec. 16, 2021

(54) FLIGHT VEHICLE

(71) Applicant: AERONEXT INC., Tokyo (JP)

(72) Inventor: Yoichi SUZUKI, Tokyo (JP)

(21) Appl. No.: 17/279,057

(22) PCT Filed: Sep. 25, 2018
(86) PCT No.: PCT/JP2018/035427

§ 371 Date: Mar. 23, 2021

(51) Int. Cl. B64D 47/08; B64C 27/08; B64C 39/02; B64D 45/08

(52) U.S. Cl. CPC B64D 47/08; B64C 27/08; B64D 2045/0085; B64D 45/08; B64C 39/024

(57) ABSTRACT

Estimation of its own position with high accuracy.

The flight vehicle includes two cameras with different focal lengths, a stabilizer for mounting at least the camera with a short focal length among the two cameras, and a flight controller that calculates the moving speed of the flight vehicle based on the images photographed by the two cameras.

### TECHNICAL FIELD

The present invention relates to a flight vehicle.

### BACKGROUND ART

A technique for estimating the flight position of a flight vehicle without relying on GPS is known. For example, Patent Literature 1 discloses an optical flow method using a multiresolution technique, a point-of-interest detector algorithm, and a combination thereof, as a method for determining the horizontal translation speed of an unmanned aerial vehicle using an ultrasound altimeter and a camera.

### PRIOR ART

### Patent Literature

[Patent Literature 1] Japanese Patent No. 5854655

### SUMMARY OF THE INVENTION

### Technical Problem

However, in the technique described in Patent Literature 1, if the altitude is higher, the resolution of the image decreases and the accuracy decreases.

The present invention has been made in view of such a background, and an object of the present invention is to provide a technique capable of estimating its own position with high accuracy.

### Technical Solution

The main embodiment of the present invention for achieving the above object provides a flight vehicle including: two cameras with different focal lengths, a stabilizer for mounting at least the camera with a short focal length among the two cameras, and a flight controller that calculates the moving speed of the flight vehicle based on the images photographed by the two cameras.

Other problems disclosed in the present application and technical solutions thereof will be clarified in the embodiments of the invention and the accompanying figures.

### Advantageous Effects

According to the present disclosure, its own position can be estimated with high accuracy.

### BRIEF DESCRIPTION OF THE DRAWINGS

FIG. 1 shows a configuration example of a flight vehicle 1 according to an embodiment of the present invention.

FIG. 2 is a view explaining the outline of the flight vehicle 1 according to the present embodiment.

FIG. 3 shows an example of a flight vehicle 1 mounted with two cameras 3 and 6 having different focal lengths.

FIG. 4 shows a second example of a flight vehicle 1 mounted with two cameras 3 and 6 having different focal lengths.

FIG. 5 shows a third example of a flight vehicle 1 mounted with two cameras 3 and 6 having different focal lengths.

FIG. 6 shows an example of a flight vehicle 1 on which cameras 3 and 6 and a range finder 4 are mounted in a horizontal direction.

FIG. 7 shows an example of a flight vehicle 1 mounted with a posture control mechanism 51 that stabilizes a loading part 7 instead of the stabilizer 5.

FIG. 8 shows an example of a flight vehicle 1 including a plurality of loading parts 7 mounted with cameras 3 and 6 and a range finder 4.

### DETAILED DESCRIPTION OF THE EMBODIMENTS

The contents of the embodiment of the present invention will be listed and described. The flight vehicle according to an embodiment of the present invention has the following configuration.

[Item 1]

A flight vehicle including:

two cameras with different focal lengths,

a stabilizer for mounting at least the camera with a short focal length among the two cameras, and

a flight controller that calculates the moving speed of the flight vehicle based on the images photographed by the two cameras.

[Item 2]

The flight vehicle as set forth in Item 1,

including a distance calculating part for calculating the distance from the photographed point based on the two photographed images respectively photographed by the two cameras.

[Item 3]

The flight vehicle as set forth in Item 1,

further including a range finder,

wherein the stabilizer is mounted with the camera with a short focal length and the range finder.

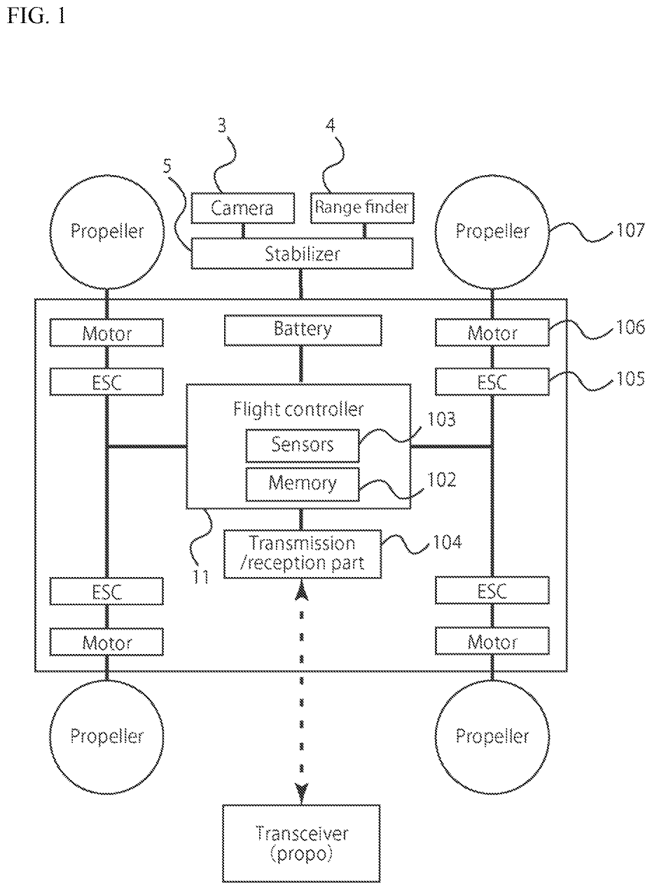

FIG. 1 shows a configuration example of a flight vehicle 1 according to an embodiment of the present invention.

The flight controller 11 can have one or more processors such as a programmable processor (e.g., central processing unit (CPU)).

The flight controller 11 has a memory 102, and can access the memory 102. The memory 102 stores logic, codes, and/or program instructions that can be executed by the flight controller 11 to perform one or more steps.

The memory 102 may include, for example, a separable medium such as an SD card or a random access memory (RAM) or an external storage device. Data acquired from the camera 3, the range finder 4, and the sensors 103 may be directly transmitted to and stored in the memory 102. For example, still image/moving image data photographed by the camera 3 is recorded in a built-in memory or an external memory. The range finder 4 can measure the distance to an object and store the measured distance in the memory 102. The range finder 4 can measure, for example, the distance (altitude) from the ground, or can measure the distance to a ceiling. The camera 3 and the range finder 4 are mounted on the flight vehicle 1 via a stabilizer 5. The stabilizer 5 is preferably arranged so that the intersection of the gimbal axes is located at the center of gravity of the flight vehicle 1.

The flight controller 11 includes a control module configured to control the state of the flight vehicle 1. For example, the control module controls a propulsion mechanism (motor 106, etc.) of the flight vehicle 1 via an ESC 105 in order to adjust the spatial arrangement, velocity, and/or acceleration of the flight vehicle having 6-degree of freedom (translational motions x, y and z, and rotational motions θx, θy and θz). The propeller 107 rotates by the motor 106 to form lift on the flight vehicle 1. The control module can control one or more of the states of the sensors 103.

The flight controller 11 is capable of communicating with a transmission/reception part 104 configured to transmit and/or receive data from one or more external devices (e.g., transceiver (propo), terminal, display device, or other remote controller). The transmission/reception part can use any suitable communication means such as wired communication or wireless communication.

For example, the transmission/reception part 104 can use one or more of a local area network (LAN), a wide area network (WAN), IR communication, wireless communication, WiFi, point-to-point (P2P) network, telecommunication network, cloud communication, and the like.

The transmission/reception part 104 can transmit and/or receive one or more of, the data acquired by sensors 103, the processing results generated by the flight controller 11, the predetermined control data, the user command from a terminal or a remote controller, and the like.

Sensors 103 according to the present embodiment may include inertial sensors (acceleration sensors, gyro sensors), GPS sensors, proximity sensors (e.g., Lidar), or vision/image sensors (e.g., cameras).

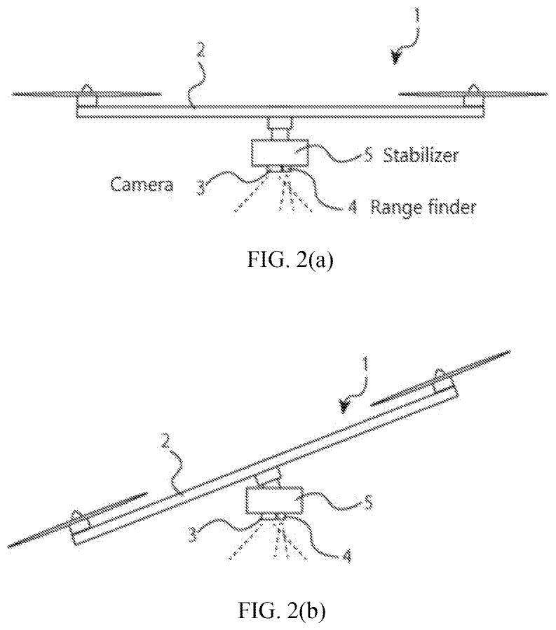

FIG. 2 is a view explaining the outline of the flight vehicle 1 according to the present embodiment. As described above, the flight vehicle 1 has a camera 3 and a range finder 4 mounted on the main body 2 via a stabilizer 5. By providing the stabilizer 5, the camera 3 and the range finder 4 are kept substantially horizontal even if the main body 2 of the flight vehicle 1 is inclined as shown in FIG. 1(b).

The range finder 4 can measure, for example, the distance (altitude) to a ground. The range finder 4 can calculate the distance, for example, by measuring the reflection time of ultrasonic waves. The range finder 4 is not limited to ultrasonic waves, and may use optics, infrared rays, laser, or the like, and any type of range finder can be adopted.

The flight controller 11 can calculate the moving speed of the flight vehicle 1 in the horizontal direction based on the distance measured by the range finder 4 and the image sequence photographed by the camera 3. For example, the flight controller 11 can calculate the distance per pixel based on the altitude measured by the range finder 4 and the angle of view of the camera 3, and calculate the speed from the moving distance per unit time. Further, a known method can be used as a method for calculating the horizontal direction moving speed of the flight vehicle 1 based on a plurality of images photographed by the camera 3.

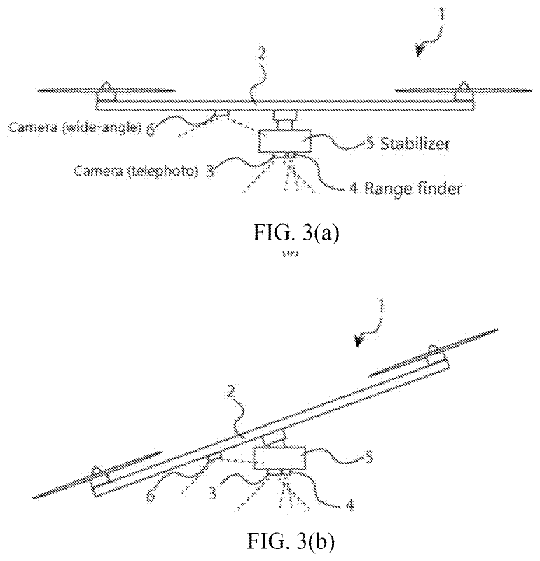

FIG. 3 shows an example of a flight vehicle 1 mounted with two cameras 3 and 6 having different focal lengths. As shown in FIG. 3(a), the stabilizer 5 is mounted with a camera 3 with a long focal length (telephoto) and a range finder 4, and the camera 6 with a short focal length (wide-angle) is mounted on the main body 2 without through the stabilizer 5. The flight controller 11 can calculate the horizontal direction moving speed of the flight vehicle 1 based on two images having different resolutions photographed by the two cameras 3 and 6. As shown in FIG. 3(b), by mounting the telephoto camera 3 on the stabilizer 5, the camera 3 can be stabilized even at a high altitude to photograph a high-definition image. Further, by stabilizing the range finder 4, the measurement of the distance (altitude) can also be performed with high accuracy. Therefore, the flight controller 11 can accurately estimate the horizontal direction moving speed.

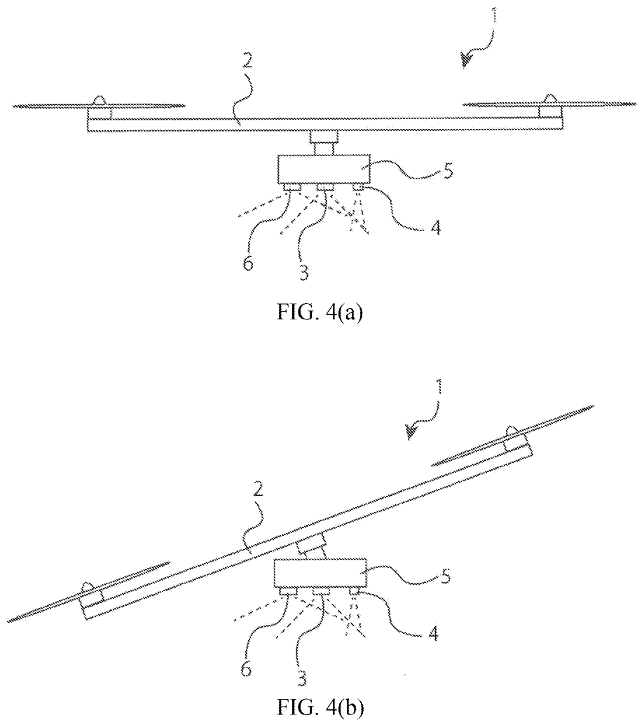

A wide-angle camera 6 may also be mounted on the stabilizer 5. FIG. 4 shows a second example of a flight vehicle 1 mounted with two cameras 3 and 6 having different focal lengths. As shown in FIG. 4(a), two cameras 3 and 6 having different focal lengths are mounted on the main body 2 via the stabilizer 5. As shown in FIG. 4(b), even when the flight vehicle 1 is inclined, the stabilizer 5 causes the cameras 3 and 6 and the range finder 4 to direct downward in the vertical direction. Thereby, by stabilizing the cameras 3 and 6, images having different resolutions can be photographed with high definition. By stabilizing the range finder 4, the distance (altitude) can be measured with high accuracy. Therefore, the flight controller 11 can accurately estimate the horizontal direction moving speed.

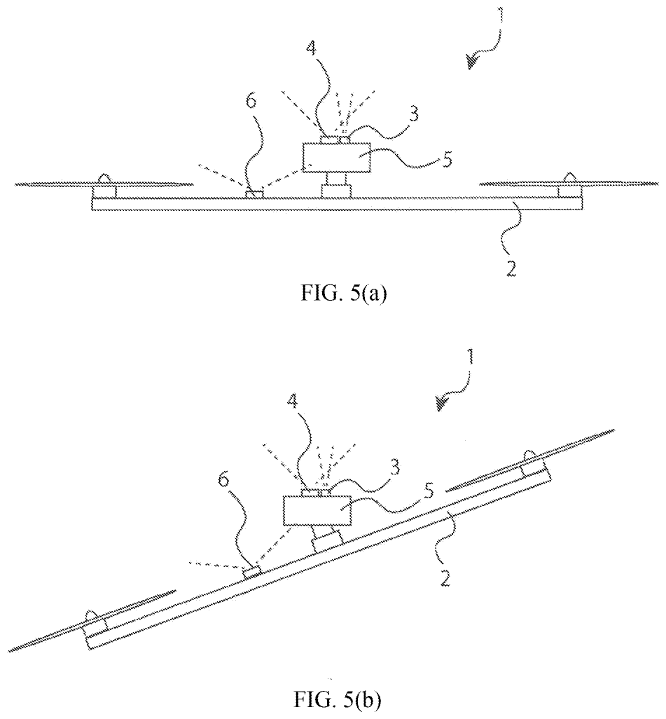

The cameras 3 and 6 and the range finder 4 may be directed upward in the vertical direction. FIG. 5 shows a third example of a flight vehicle 1 mounted with two cameras 3 and 6 having different focal lengths. As shown in FIG. 5(a), the cameras 3 and 6 and the range finder 4 are arranged on the upper surface of the main body 2. Thereby, the cameras 3 and 6 photograph an image in the vertical upward direction, and the range finder 4 measures the distance in the vertical upward direction. For example, in a large-scale exhibition hall or the like, even in the situation where the floor surface is concrete or tile and it is difficult to extract a point-of-interest, the ceiling can be photographed and gripped to measure the distance to a ceiling, and the horizontal movement distance can be calculated based on these measurements.

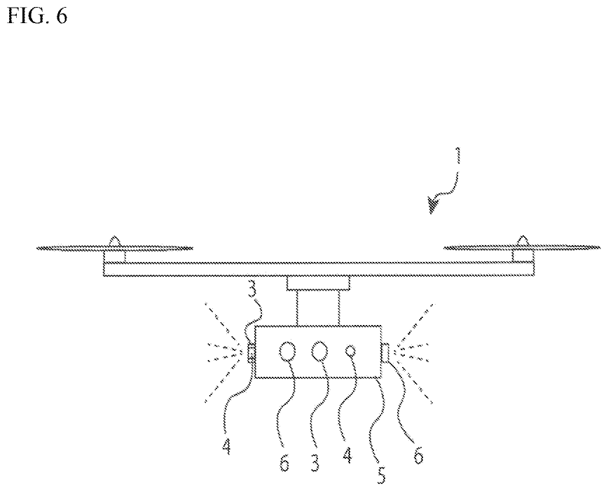

The cameras 3 and 6 and the range finder 4 may also be directed in a horizontal direction. FIG. 6 shows an example of a flight vehicle 1 on which cameras 3 and 6 and a range finder 4 are mounted toward a horizontal direction. In the example of FIG. 6, cameras 3 and 6 and a range finder 4 are mounted on each side surface of the stabilizer 5. The flight controller 11 can estimate the moving speed on a plane parallel to the side surface in accordance with the image photographed by two cameras 3 and 6 for each side and the distance to an object existing in the horizontal direction measured by the range finder 4. Thus, for example, even on the water surface of the indoor pool, it becomes possible to estimate the horizontal direction moving speed of the flight vehicle 1 by the cameras 3 and 6 and the range finder 4 toward the side wall, and to fly autonomously on the water surface.

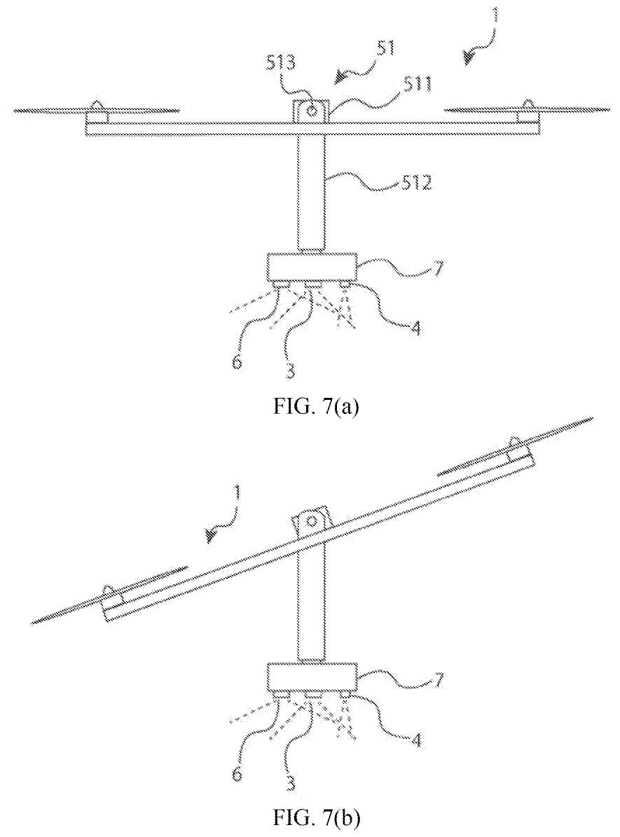

The stabilizer 5 may be a mechanism that stabilizes the posture of the loaded object (for example, the camera 3 and the range finder 4). FIG. 7 shows an example of a flight vehicle 1 mounted with a posture control mechanism 51 that stabilizes the loading part 7 instead of the stabilizer 5. The posture control mechanism 51 includes a support member 511 arranged on the upper surface of the main body 2 of the flight vehicle 1 and an arm 512 connected to the support member 511. A loading part 7 is provided at the tip part of the arm 512. The arm 512 and the support member 511 are rotatably connected by a hinge 513. The hinge 513 is provided at the center of gravity of the flight vehicle 1. Further, the hinge 513 is configured to be rotatable with respect to an orthogonal axis. Thus, the arm 512 can be rotated 360 degrees around the center of gravity of the flight vehicle 1. Therefore, even if the main body 2 of the flight vehicle 1 is inclined, the arm 512 is stable in the vertical direction as shown in FIG. 7(b). The cameras 3 and 6 and the range finder 4 mounted on the loading part 7 are directed toward the vertical lower direction. Therefore, the cameras 3 and 6 can photograph high-definition images, and the range finder 4 can measure a stable distance (altitude).

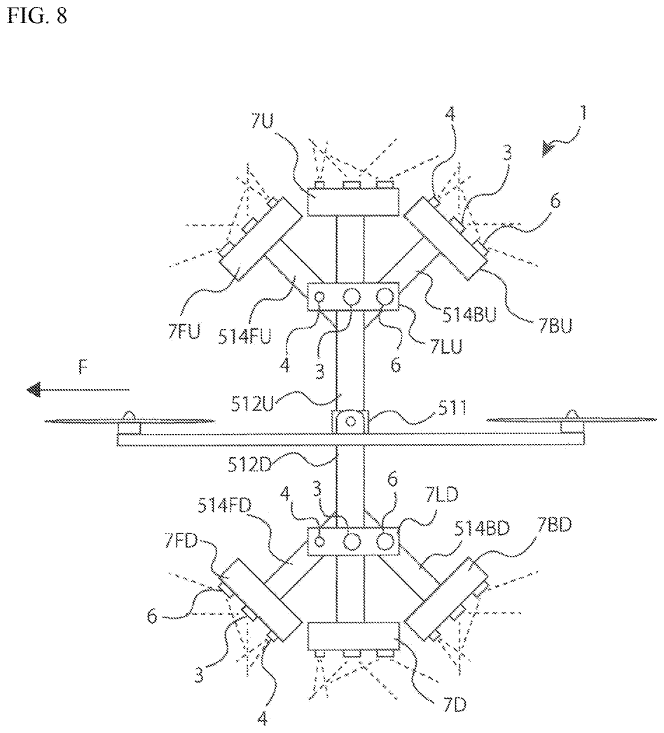

The loading parts 7 mounted with the cameras 3 and 6 may be provided in a plurality. FIG. 8 shows an example of a flight vehicle 1 including a plurality of loading parts 7 mounted with cameras 3 and 6 and a range finder 4. In the example of FIG. 8, the arrow F indicates the front part of the travelling direction of the flight vehicle 1, and the up and down are the vertical direction. As shown in FIG. 8, two arms 512U and 512D are rotatably connected to the support member 511 upward and downward. At the tips of the arms 512U and 512D, loading parts 7U and 7D are provided, respectively, to direct the surfaces on which the cameras 3 and 6 and the range finder 4 are mounted (hereinafter referred to as mounting surfaces) towards the upward and downward direction. Further, the arms 512U and 512D are provided with loading parts 7LU and 7LD, respectively, which direct the mounting surfaces to the left side of the flight vehicle 1. the arms 512U and 512D are also provided with loading parts (not shown), which direct the mounting surfaces on the right side of the flight vehicle 1 on the opposite sides of the loading parts 7LU and 7LD. Thus, the cameras 3 and 6 photograph images having different resolutions for each of the up, down, left, and right of the flight vehicle 1, and the range finder 4 can measure the distance to a peripheral object of the flight vehicle 1. Therefore, the flight controller 11 can estimate the moving speeds of the flight vehicle 1 along up, down, left, right, front, and rear directions by using any of the up, down, left, or right image and the distance.

Further, as shown in FIG. 8, an inclined arm 514 is connected to the arm 512, a loading part 7 is provided at the tip of the arm 514, thus making it possible to measure an image and a distance in an inclined direction at a certain angle with respect to the vertical direction. In the example of FIG. 8, an arm 514 inclined at an inclination angle of 45 degrees is connected to the front and rear of the arm 512. The upper arm 512U of the flight vehicle 1 is connected to an arm 514FU provided with a loading part 7FU in which the mounting surface is directed toward at the front side upper 45 degrees of the flight vehicle 1, and is connected to an arm 514BU provided with a loading part 7BU in which the mounting surface is directed toward at the rear side upper 45 degrees of the flight vehicle 1. Further, the lower arm 512D of the flight vehicle 1 is connected to an arm 514FD provided with a loading part 7FD in which the mounting surface is directed toward at the front side lower 45 degrees of the flight vehicle 1, and is connected to an arm 514BD provided with a loading part 7BD in which the mounting surface is directed toward at the rear side lower 45 degrees of the flight vehicle 1. In this way, in the example of FIG. 8, it is possible to photograph an image at about 360 degrees of the flight vehicle 1. Thereby, the flight controller 11 can estimate the moving speed in the up, down, left, right, front, and rear directions.

As described above, according to the flight vehicle 1 of the present embodiment, since the camera 3 and the range finder 4 are mounted on the flight vehicle 1 via the stabilizer 5, the photographing and measuring directions of the camera 3 and the range finder 4 can be stabilized. Thereby, it is possible to improve the estimation accuracy of the moving speed of the flight vehicle 1 using the image and the distance. Such a configuration according to the flight vehicle 1 of the present embodiment can be used in various flight vehicles regardless of purpose, from hobby use to industrial use. In addition, the usage environment can be outdoors or indoors. The moving speed of the flight vehicle 1 can be estimated in accordance with the image photographed by the camera and the distance measured by the range finder, and the position of the flight vehicle 1 can be estimated from the moving speed. Therefore, it can be used as a substitute for GPS in places where GPS does not operate, such as under bridges, valleys, and caves. Further, it can function as a backup when some sort of trouble occurs in the acquisition of GPS signals or the use of GPS.

Further, in the case of mounting a plurality of cameras having different focal lengths, when deviation occurs at the optical axis of a camera with a longer focal length, the error becomes large when calculating the moving distance from the distance per pixel. According to the flight vehicle 1 of the present embodiment, the camera 3 having a longer focal length can be stabilized by the stabilizer 5. Therefore, it is possible to estimate the moving speed with high accuracy.

Although the present embodiment has been described above, the above-described embodiment is merely an example for facilitating the understanding of the present invention, and should not be construed as limiting the present invention. The present invention can make some modifications and improvements without departing from the spirit thereof, and the present invention includes an equivalent thereof.

For example, in the present embodiment, it is assumed that the range finder 4 measures the distance, but the present invention is not limited thereto. It is also possible to omit the range finder 4 and estimate the distance from the object being photographed using the two images by the cameras 3 and 6. This can be achieved by using general stereo image processing. In this case, by stabilizing the cameras 3 and 6 with the stabilizer 5, the moving speed and the distance (altitude) can be estimated with high accuracy.

Further, in the example of FIG. 7, the cameras 3 and 6 and the range finder 4 are arranged on the loading part 7 provided at the tip of the arm 512. The moving speed of the flight vehicle 1 is estimated in accordance with the images photographed by the cameras 3 and 6 and the distance measured by the range finder 4, but it is preferable that the flight controller 11 corrects the moving speed according to the length of the arm 12 (the distance from the hinge 513 to the mounting surface of the loading part 7).

Further, in the example of FIG. 8, the mounting surface of the loading part 7 is directed diagonally upward and diagonally downward in the front-rear direction, but may be oriented toward the front-rear direction by the same manner as in the left-right direction.

Further, in the present embodiment, the camera 3 and the distance meter 4 are fixed to the stabilizer 5, but the range finder 4 may be movable. In this case, the flight controller 11 acquires a grip point (that is, a point from which an amount-of-characteristic is extracted, hereinafter referred to as a grip point) from the image photographed by the camera 3. The range finder 4 may be rotated to change the directivity direction of the range finder 4 so as to emit ultrasonic waves or a laser toward the acquired grip point. As a result, the grip point used for analyzing the image from the camera 3 and estimating the moving speed can be substantially matched with the point for measuring the distance from the range finder 4. Therefore, when calculating the distance per pixel in the image, it is possible to accurately obtain the distance to the grip point used to calculate the distance moved by the grip point (distance in the horizontal direction), and to improve the estimation accuracy of the moving speed.

### DESCRIPTION OF REFERENCE NUMERALS

1: flight vehicle
2: main body
3: camera
4: range finder
5: stabilizer
6: camera
7: loading part
51: posture control mechanism
511: support member
512: arm
513: hinge

1. A flight vehicle comprising:
two cameras with different focal lengths;
a stabilizer for mounting at least the camera with a short focal length among the two cameras; and
a flight controller that calculates the moving speed of the flight vehicle based on images photographed by the two cameras.

2. The flight vehicle according to claim 1,
comprising a distance calculating part for calculating the distance from the photographed point based on the two photographed images photographed by the two cameras, respectively.

3. The flight vehicle according to claim 1,
further comprising a range finder,
wherein the stabilizer is mounted with the camera with a short focal length and the range finder.

4. The flight vehicle according to claim 2,
further comprising a range finder,
wherein the stabilizer is mounted with the camera with a short focal length and the range finder.

5. The flight vehicle according to claim 1,
wherein the two cameras are mounted to direct downward.

6. The flight vehicle according to claim 2,
wherein the two cameras are mounted to direct downward.

7. The flight vehicle according to claim 3,
wherein the two cameras are mounted to direct downward.

8. The flight vehicle according to claim 4,
wherein the two cameras are mounted to direct downward.

9. The flight vehicle according to claim 1,
wherein the two cameras are mounted toward a horizontal direction.

10. The flight vehicle according to claim 2,
wherein the two cameras are mounted toward a horizontal direction.

11. The flight vehicle according to claim 3,
wherein the two cameras are mounted toward a horizontal direction.

12. The flight vehicle according to claim 4,
wherein the two cameras are mounted toward a horizontal direction.

13. A method for calculating a moving speed of a flight vehicle having a flight controller comprising:
obtaining, by the flight controller, images photographed by the two cameras,
wherein the two cameras are mounted on the flight vehicle,
wherein at least the camera with a short focal length among the two cameras is mounted on a stabilizer which is equipped on the flight vehicle,
calculating, by the flight controller, the moving speed of the flight vehicle based on the images.

14. The method according to claim 13,
further calculating the distance from the photographed point based on the two images photographed by the two cameras, respectively.
